(19) United States
(12) Patent Application Publication
(10) Pub. No.: US 2016/0314466 A1
(43) Pub. Date: Oct. 27, 2016

(54) SYSTEMS AND METHODS FOR ROLL-UP PAYMENTS AUGMENTED BY PRICE MATCHING REFUNDS

(71) Applicant: Wal-Mart Stores, Inc., Bentonville, AR (US)

(72) Inventor: Anthony G. Wind, III, Gravette, AR (US)

(21) Appl. No.: 15/130,075

(22) Filed: Apr. 15, 2016

Related U.S. Application Data
(60) Provisional application No. 62/152,410, filed on Apr. 24, 2015.

(51) Int. Cl. G06Q 20/40; G06Q 20/20

(52) U.S. Cl. CPC G06Q 20/407; G06Q 20/201

(57) ABSTRACT

A user specifies a wish list of items and creates an account. Transactions for customers with accounts are reported to a server system prior to processing payment. A transaction price is incremented, e.g. rounded up, and the incremented amount is added to a roll-up account of the customer. The roll-up account of the customer may also be augmented by refunds assigned to the customer in response to determining that a third party offers a lower price for a product purchased by the customer, the refunds being determined according to the difference between the purchase price for the product and the lower third party price. Upon determining that the roll-up account has sufficient funds to purchase an item of the wish list, the roll-up account is reduced by the purchase price and shipping of the item is invoked.

### CROSS-REFERENCE TO RELATED APPLICATIONS

This application claims the benefit of U.S. Provisional Patent Application Ser. No. 62/152,410, filed Apr. 24, 2015, and titled “Systems and Methods for Roll-Up Payments Augmented by Price Matching Refunds”, the entire contents of which are hereby incorporated herein by reference.

### FIELD OF THE INVENTION

This invention relates to systems and methods for facilitating payment for purchases by customers.

### BACKGROUND OF THE INVENTION

People generally have desired products and/or services to purchase that are, for example, outside their current financial capacity. Saving money out of a steady income to purchase a desired item may be difficult due to previous financial obligations. Saving money for an expensive durable good (e.g., an appliance) may be particularly challenging given the scale of the up-front purchase price. Shoppers further desire to find the lowest price for everyday items that are not aspirational purchases.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment suitable for implementing methods in accordance with embodiments of the invention;

FIG. 2 is a schematic block diagram of an example computing device suitable for implementing methods in accordance with embodiments of the invention;

FIG. 3 is a process flow diagram of a method for generating roll-up payments and for assigning refunds toward roll-up purchases in accordance with an embodiment of the present invention;

FIG. 4 is a process flow diagram of a method for creating a wish list in accordance with an embodiment of the present invention;

FIG. 5 is a process flow diagram of a method for associating a transaction with a user having a wish list in accordance with an embodiment of the present invention;

FIG. 6 is a process flow diagram of a method for processing roll-up payments in accordance with an embodiment of the present invention; and

FIGS. 7A and 7B are schematic block diagrams of methods for generating refunds based on price differences in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

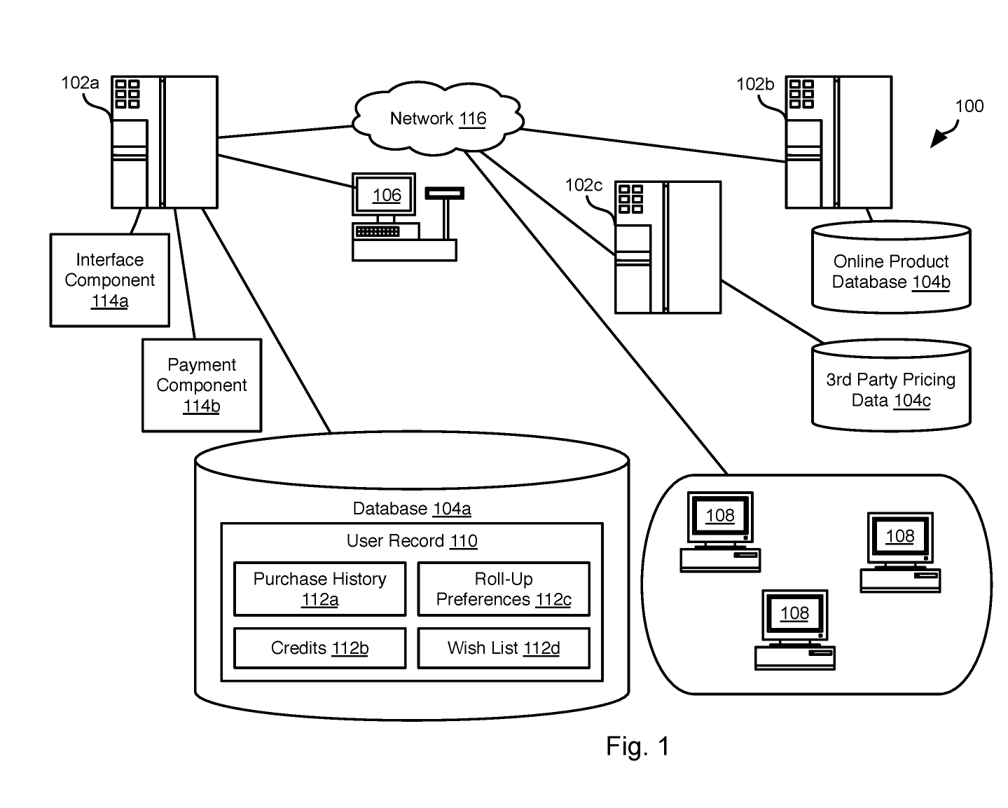

Referring to FIG. 1, a network environment 100 may be used to implement methods as described herein. The environment 100 may include a server system 102a associated with a corporate parent or controlling entity having one or more retail establishments associated therewith. The retail establishments may house point of sale devices (POS) 106 on which transactions may be concluded. Records of transactions may be transmitted to the server system 102a by the POSs 106 at various retail establishments. The POS 106 may also be part of an e-commerce system. The e-commerce system may include, for example, a web-application that permits customers to purchase various products and/or services over the Internet.

In some embodiments, data regarding third parties that is used according to the methods disclosed herein may be gathered from various sources. For example, a server 102b of one entity may provide a website providing access to an online product database 104b, which may include access to product records including product prices and corresponding product identifiers and other descriptive information. The database 104b may also include a publicly accessible website or the like listing advertisements for products offered for sale in a retail establishment.

In some embodiments, data regarding third parties may be obtained from a server system 102c operated by a data gathering entity. For example, the server system 102c may store third party pricing data 104c. The pricing data may include data gathered from advertisements published by retail entities. Pricing data could include entries including fields such as an entity identifier, location, price, product identifier (e.g. UPC), a date the product was offered at the price, or the like. The pricing data may be gathered and be provided within N day of Hours from when it was published. For example, pricing data may be provided the next day, 48 hours, or 72 hours, after initially publicized.

The server system 102a may access a database 104a, which may include a plurality of user records 110. A user record 110 may be associated with a particular user who may be identified by a unique customer identifier. The user may have access to some or all of the data in the user record 110 and a user name and password may be associated with the user record and with which a user may log in the server system 102a in order to obtain access to the user record 110.

The user record 110 may include such data as a purchase history 112a including a record of previous transactions conducted by the user associated with the user record 110 at the various POSs 106 associated with the server system 102a. The user record may further include a record of credits 112b assigned to the user associated with the user record 110 as well as a redemption or usage of such credits. The methods by which the credits 112b are assigned and used are described in greater detail below.

The illustrated system 100 may be used to provide refunds in accordance with differences between a price paid and third-party prices for the same product. The illustrated system further provides for roll-up payments that are added to transactions in order to accumulate funds in a roll-up account for purchase of an item. Refunds assigned according to price differences may also be applied to the roll-up account. The server 102a may execute an interface component 114a and payment component 114b for processing roll-up payments and facilitating purchase of items using roll-up payments.

The interface component 114a may receive roll-up preferences 112c and one or more wish lists 112d from a user and store these in the user record 110 for that user. The interface component 114a may receive sales transaction information from a POS 106 and provide updated sales transaction information to that POS 106 during a transaction, as described in greater detail below.

The transaction information received from a POS 106 may include, for example, a transaction amount and customer identification information. The updated sales transaction information 106 may include, for example, an increased transaction amount consistent with specified roll-up payment parameters associated with the customer. It is appreciated that the interface component 114a may include one or more system interfaces that can be configured to receive particular settings with respect to the administration of roll-up payments. In one embodiment, the interface component 114a receives wish list information 112d for a user and stores this wish list information 112d in the user record 110 of that user and generates purchase requests for purchase of wish list items as described in greater detail below. In this embodiment, the wish list information 112d includes one or more items that are available to be purchased. The items on the wish list may include a product and/or a service.

The purchase requests provided by the interface component 114a include information indicating the wish list item that is being purchased and information identifying the user associated with the wish list. For example, the purchase requests may include a home address of the user to ship a purchased product. In addition, the wish list information may further include a priority associated with each item on the list. The roll-up payments may be applied to items with a higher priority first as further described below with reference to the roll-up payment component 114b.

In one embodiment, the roll-up payment component 114b is configured to generate updated sales transaction information based on the received sales transaction information. In this embodiment, the roll-up payment component 114b is configured to match the customer identification information in the received sales transaction information with identification information associated with a registered customer (e.g., stored in data store). If the received customer identification information matches the identification information associated with a registered customer, e.g. a user having a user record 110 associated therewith, the roll-up payment component 114b may increase the transaction amount to generate updated sales transaction information 106. The roll-up payment may be applied to the wish list associated with the registered customer by increasing an amount of available funds associated with the wish list by an amount equal to the roll-up payment.

In one embodiment, the roll-up payment component 114b is configured to generate purchase requests based on wish list information 112d and sales transaction information. As discussed above, the interface component 114a may be configured to increase an amount of available funds associated with a particular wish list. The roll-up payment component 114b may be further configured to generate a purchase request for a particular item responsive to the amount of available funds associated with the wish list transgressing a threshold equal to the purchase price of a wish list item. The purchase request may include an indication of the item purchased from with wish list and information identifying the user associated with the wish list. For example, the purchase request may indicate that a user has purchased a new home appliance and include a home address of the user to ship the new home appliance. The roll-up payment component 114b may further decrease the amount of available funds associated with the wish list by an amount equal to the purchase price of the item.

As noted above, the database 104a may store user records 110 each associated with a particular user. User records 110 may be created upon a user registering with the server system 102a. A user record 110 includes information for registered customers to uniquely identify the registered customers based on the received sales transaction information in addition to any association with various wish lists. For example, the registered customer database may store a credit card number associated with a registered customer and an association with a particular wish list.

In this example, the roll-up payment component 114b may match a credit card number received in the sales transaction information with the credit card number stored in a user record 110 and apply the roll-up payment to the wish list associated with that user record 110. The user record 110 may further include customer roll-up preferences 112c. For example, customer roll-up preferences 112c may indicate the scale of the roll-up payment (e.g., round up to the nearest tenth of a United States dollar).

In some embodiments, the wish list information 112d of a user record 110 may include information defining one or more wish lists and information associated therewith. Each of the wish lists may include one or more items (e.g., a product and/or a service), an amount of available funds, and optionally a priority associated with each item. As discussed above, the roll-up payment component 114b may apply the rollup payment to high priority items before applying the roll-up payment to low priority items. Each of the wish lists may have one or more associated users who are the targeted recipients of the purchased wish list items.

Customers may access the server system 102a in order to participate in the methods described herein by means of user computing devices 108 that may be embodied as desktop or laptop computers, tablet computers, smart phones, or the like. Communication among servers 102a-102c, POS 106, and computing devices 108 may occur over a network 116 such as the Internet, local area network (LAN), wide area network (WAN) or any other network topology. Communication may be over any wired or wireless connection.

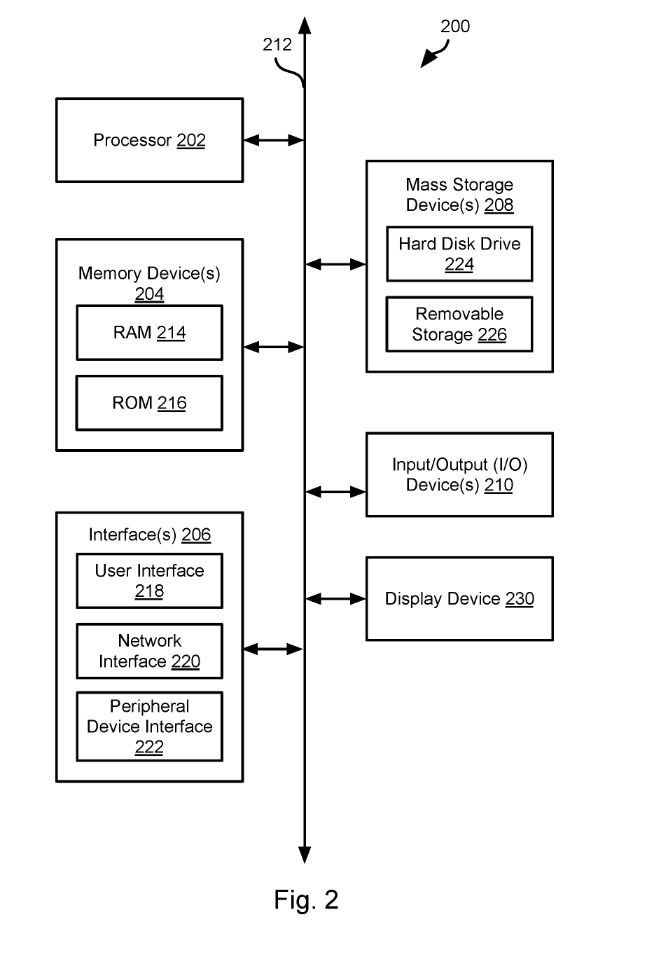

FIG. 2 is a block diagram illustrating an example computing device 200. Computing device 200 may be used to perform various procedures, such as those discussed herein. A server system 102a-102c, POS 106, and user computing device 108 may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, tablet computer and the like. A server system 102a-102c may include one or more computing devices 200 each including one or more processors.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more user interface elements 218. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, and I/O device(s) 210 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

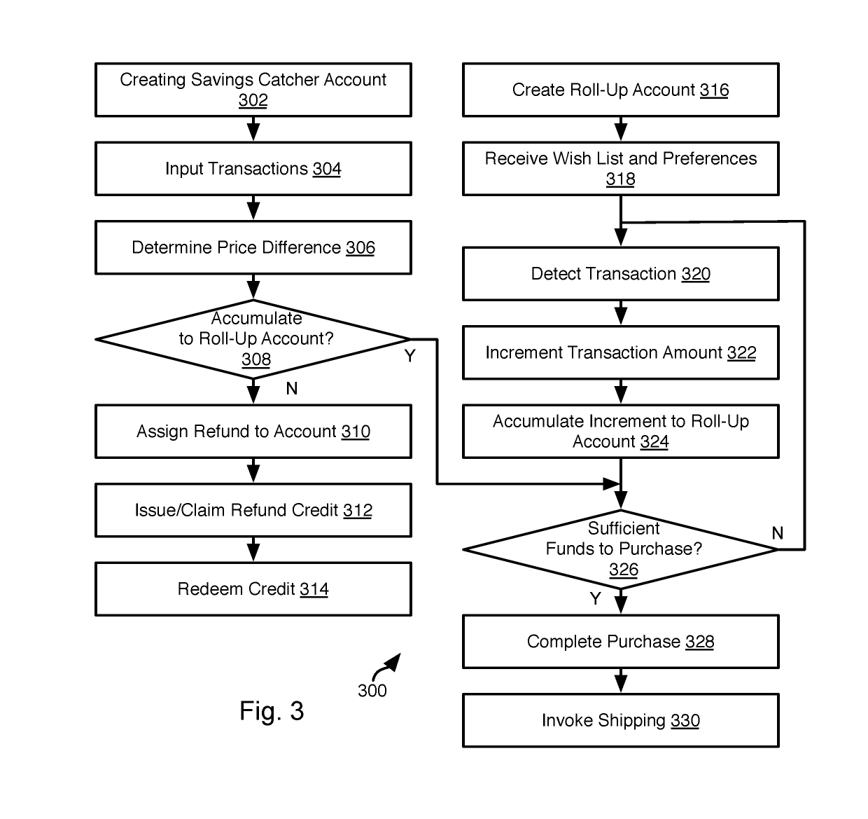

Turning now to FIG. 3, the system 100 described above may be used to perform the illustrated method 300. For example, the server system 102a may perform the illustrated method 300. The method 300 may include creating 302 a savings catcher account for a user. Creating 302 the savings catcher account may be performed automatically upon detecting new user (e.g. new credit card number or other identifying information) for a transaction or in response to the user filling a form in a website provided by the server system 102a to a device 108 operated by the user. Creating 302 the account may include establishing a username and password for the account and collecting profile information such as name, gender, age, interests, or other demographic or taste information. Creating 302 the savings catcher account may include creating a user record 110 for storing the above-noted information for the user.

The method 300 may further include inputting transactions of the user at 304. For example, a transaction identifier may be input by the user to the server system 102a in association with the account of the user, e.g. while the user is logged into the server system 102a form the user's computing device 108. The transaction identifier may identify a transaction conducted on a POS 106. For example, the transaction identifier may enable the server system 102a to retrieve data describing a transaction, such as location, store identifier, items purchased, prices paid for items purchased, discounts or coupons applied to items of the transaction, a date and time of the transaction, a user identifier associated with the transaction, or other information.

A transaction may be received automatically from a POS 106 without any action by the user. For example, the transaction may have a credit card or other identifier associated with a user record 110. The transaction may then be associated with that user record 110 and the other steps of the method 300 performed with respect to that transaction.

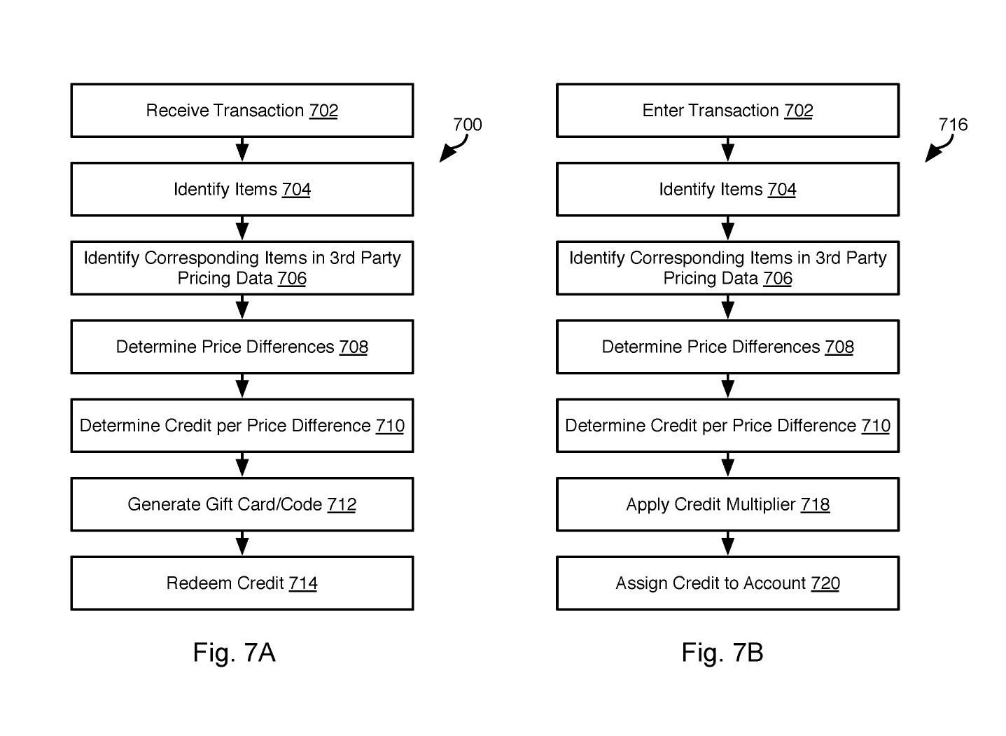

The method 300 may further include determining 306 price differences for the transaction. In particular, the prices paid for items of the transaction received at step 304 may be compared to third party prices for a corresponding product. A method by which the price differences may be computed is described below with respect to FIGS. 7A and 7B. Where a lower third party price is found for an item, the difference between the purchase price for the item and the lower third party price may be added to a refund amount for that transaction.

The method 300 may include determining 300 whether a user preference for the user indicates that the refund amount is to be applied to a roll-up account. If not, the refund is assigned 310 to a refund account of the user. The refunds assigned 310 for one or more accounts may be issued 312 to the user in the form of gift cards, balances assigned to a debit account, or the like. The credit may then be redeemed 314 to fund other transactions.

The user may also create 316 a roll-up account. Creating 316 a roll-up account may be performed in the same manner as creating 302 a saving catcher account. In some embodiment, the same account may be used as both a saving catcher and roll-up account. For example, a user may indicate that an account is to be used for one or both of savings catcher and roll-up methods as described herein.

The method 300 may include receiving 318 by the server system 102a from a user, e.g. a user computing device 108, roll-up preferences for the user and storing these preferences in the user account. The preferences may include some or all of the preferences 112c and wish list information 112d as described above. In particular, the wish list 112c may store a list of item identifiers selected by a user for inclusion in a wish list. As noted below, items may be purchased as sufficient funds are accumulated to purchase them. Accordingly, the wish list 112c may include a listing of unpurchased item identifiers, the purchase of which has not been funded.

The method 300 may include detecting 320 a transaction in progress as reported by a POS 106. In particular, a POS 106 may report a transaction in progress at some point between input of the items of the transaction to the POS 106 and payment for the items. In particular, the POS 106 may report to the server system 102a the price of the transaction and a user identifier, e.g. identification number or credit card number of a user paying for the transaction. The price may be a bottom line transaction price after calculating taxes, applying coupons, or any other modifications to the sum of the purchase prices of the items of the transaction.

The method 300 may include incrementing 322 the purchase price of the transaction according to user preferences. As noted above, a fixed amount may be added to the transaction price, the purchase price may be incremented to the nearest 0.10 X value, where X is a unit of currency (dollars, pounds, yen, etc.), 1 X value, 10 X value, or the like. For example, where the transaction price is 118.83, the transaction price may be increased to 118.90, 119.00, or 120.00 for a round up of 0.10 X , 1 X, or 10 X respectively. The amount of the increment may be set according to user preferences received at step 318.

The incremented purchase price may be returned to the POS 106, which then processes payment for the increased purchase amount. The amount of the increment to the transaction price may then be accumulated 324 to the roll-up account of the user. For example, the roll-up account of the user may store a funding amount that includes the funds that have been accumulated at one or more iterations of one or both of step 324 and step 308. For example, for the purchase price of 118.83 and a round up of 0.10 X, a value of 0.07 will added to the roll-up account of the user.

Steps 320-324 may be performed repeatedly for multiple transactions thus accumulating the transaction price increments to the roll-up account. The roll-up account is further augmented by refund amounts directed to the roll-up account in response to determining 308 that a refund determined at step 306 should be added to the roll-up account.

If the amount of the roll-up account is determined 326 to be sufficient to fund purchase of a wish list item, then purchase of that item may be completed 328 and shipping of that product invoked 330. Completing 328 the purchase may include deducting the purchase price for the item from the roll-up account.

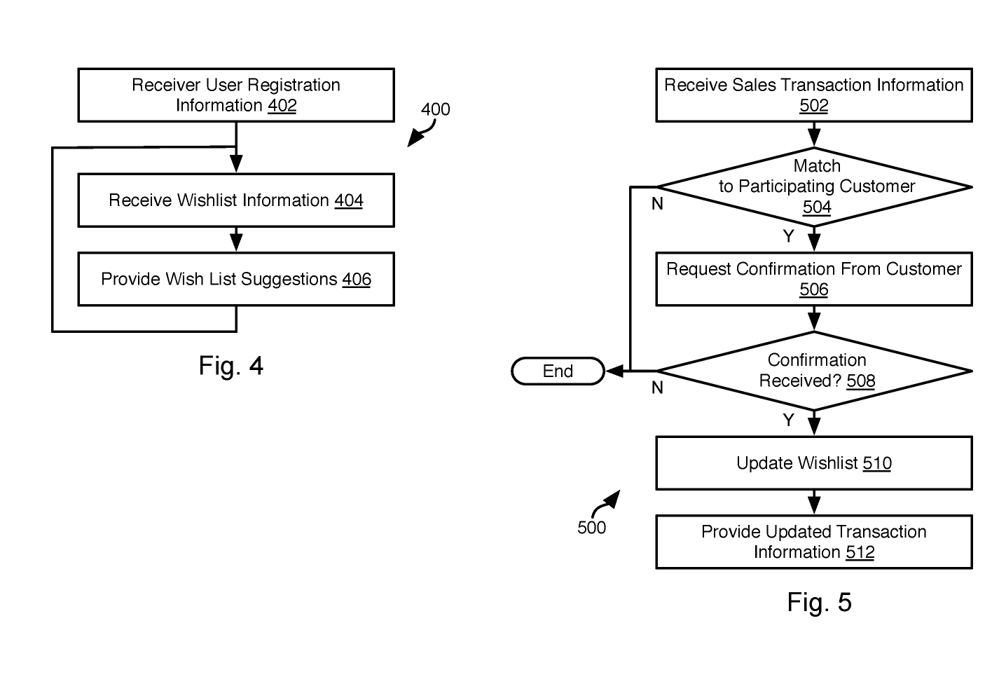

FIG. 4 illustrates a method 400 that may be used to create 316 a roll-up account for a user and receive 318 a wish list from that user. The method 400 may be executed by the server system 102a with respect to inputs received from a computer 108 of the user associated with a user record 110 of the user.

The method 400 includes receiving 402 by the server system 102a user registration information, such as contact information associated with the user (e.g., name, phone number, and home address). At step 404, the server system 102a receives wish list information identifying one or more items to include on the wish list associated with the user. The wish list items may include one or more products and/or services and optionally a priority associated with each product and/or service. For example, the wish list information may include information identifying a first product with a low priority and a second product with a high priority.

At step 406, the server system 102a provides one or more suggested items to add to the wish list to the user. The system may suggest items by matching one or more characteristics associated with the items already included in the wish list and available items. For example, the wish list may include a television and the system may provide a suggested addition of a television coaxial cable. In addition, the system may suggest items based on a purchase history associated with the user in cases where the user is also a registered customer associated with the wish list. For example, the registered customer (and user) may purchase grill accessories and the system may provide a suggested addition of a new grill to the wish list. The server system 102a may return to step 404 to receive additional wish list information from the user. In some embodiments, the step of providing 406 wish list suggestions may be omitted.

FIG. 5 illustrates a method 500 that may be used to augment transaction prices in order to fund a roll-up account. The method 500 may be performed by a server system 102a. The roll-up payment process 500 generates roll-up payments for registered customers and applies the roll-up payment to one or more wish lists. The server system 102a receives 502 sales transaction information. The received sales transaction information may include a transaction amount and information identifying the customer participating in the transaction. The system determines 504 whether there is a match between the customer identifying information received in the sales transaction information and a registered customer. If the system matches 504 the received customer identification information with a registered customer, the system may proceed to request 506 confirmation from the registered customer. The request for confirmation may include, for example, an indication of the associated wish list and the amount of the roll-up payment. If no matching customer is found 504, the method 500 may end the sales transaction proceeds without a roll-up payment.

The server system 102a may determine 508 whether confirmation to make the roll-up payment was received from the registered customer in response to the request 506 for confirmation system. If confirmation is not found 508 to have received, the method 500 ends. In some embodiments, roll-up payments are made regardless of confirmation once the user has registered according to the method 400 provided there is at least one item in at least one wish list of the user. Accordingly, steps 506-508 may be omitted in such embodiments.

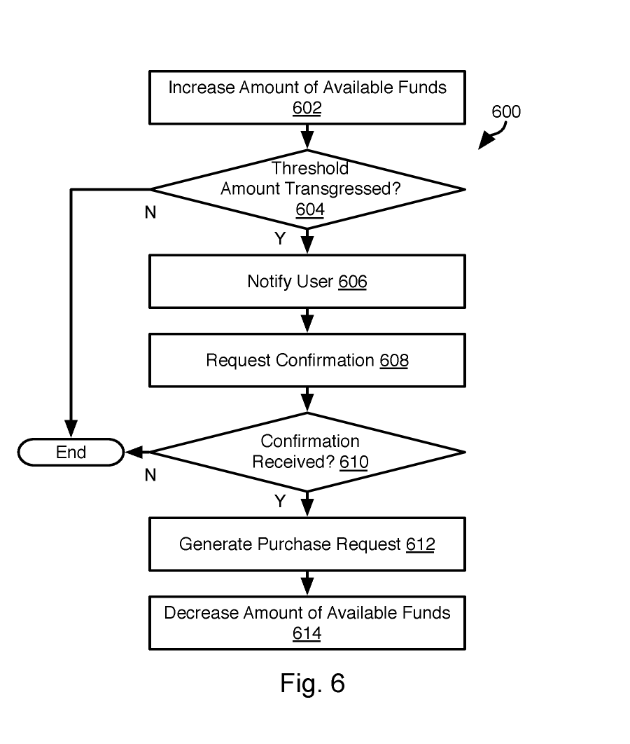

If confirmation is found 508 to have been received or confirmation is not part of the method 500, the method 500 may include updating 510 one or more wish lists of the user. An example update wish list subroutine is described further below with regard to wish list update process 600 in FIG. 6.

The server system 102a then provides 512 updated sales transaction information to the POS 106 from which sales transaction information was received 502. The updated sales transaction information may include an increased transaction amount as described herein. In particular, a fixed amount or rounding amount as proscribed by the user's preferences may be added to the transaction amount as received at step 502 as described above and the increased transaction amount may then be provided 512 to the POS 106 of step 502.

FIG. 6 is a flow chart illustrating a wish list update process 600, such as may be performed by the server system 102a at step 510 of the process 500. The wish list update process 600 updates information associated with the wish list responsive to processing of a roll-up payment or receiving a refund based on determined price differences (see step 308 of FIG. 3).

The wish list update process 600 may include increasing 602 the amount of available funds associated with the wish list. The increased amount of available funds may be equal to the roll-up payment amount or an increase due to a refund determined 308 to be added to the roll-up account of a user rather than refunded. The system may also apportion the roll-up payment or refund between multiple wish lists based on preference information associated with the registered customer (e.g., preference information as provided within a user interface or control).

The method 600 may include determining 604 whether the amount of available funds associated with the wish list transgressed a threshold equal to the purchase price of at least one item on the wish list. In embodiments where the wish list includes a priority associated with each item on the wish list, the system may determine whether the amount of available funds transgressed a threshold equal to the purchase price of the highest priority item on the wish list. If the amount of available funds has transgressed the threshold, the system proceeds to notify 606 the user associated with the wish list. Otherwise, the method 600 ends.

The server system 102a may request 608 confirmation from the user to purchase an item on the wish list with the available funds. The confirmation may include an indication of the item that is available to be purchased with the current amount of available funds. If confirmation is found 610 to have been received, the server system 102a may proceed to generate 612 a purchase request for the item from the wish list. The purchase request may include an indication of the purchased item and a target recipient (e.g., the user). Otherwise, the method 600 ends. In some embodiments, confirmation is not obtained, such that steps 608 and 610 or steps 606-610 are omitted. The server system 102a may then decrease 614 the amount of available funds associated with the wish list by an amount equal to the purchase price of the purchased item.

FIG. 7A illustrates an example of a method 700 that may be used to provide credits to users based on price difference between a price paid and third party prices. The method 700 may include receiving 702 a record of a transaction. A record of a transaction may include such data as a date of the transaction, a location where the transaction occurred, an identifier of the POS 106 at which the transaction occurred, an identifier of the customer that was a party to the transaction, and other information. The transaction record may further include various <product,price> entries that list a product identifier and a price paid for the product corresponding to that product identifier. Other data may include taxes paid for the entire transaction and/or for specific item identifiers. Any discounts due to coupons or price matching may also be noted for each item identifier for which such price adjustments were applied. The transaction record may be transmitted from the POS 106 to the server system 102a. The transaction record may additionally or alternatively be transmitted to a customer in electronic form and/or by means of a printed copy. The transaction record may be associated by the server system with the user data 110 of the user with whom the transaction was conducted, such as using a credit card number or identifier supplied to the POS at the time of concluding the transaction and included in, or associated with, the transaction record. For example, the transaction record may be in the form of an electronic receipt provided to the customer.

The step of receiving 702 the receipt may include receiving a transaction identifier from a user computing device 108 through a portal such as a website hosted by the server system 102a. The transaction identifier may uniquely identify the transaction record and may be printed on a paper receipt to enable the customer to take advantage of the methods disclosed herein and/or for other purposes. Receiving 702 the receipt may include receiving, by the server system 102a, a selection of the transaction in a listing of transactions presented in a portal provided by the server system 102a or by an application for viewing receipts stored locally on a user computing device 108. For example, transactions may be made available to a user in the form of electronic receipts stored in an account of a user and recording transactions conducted by the user. In some embodiments, all transactions of a user may be submitted for review according to the method 700. For example, where a user has installed a mobile application for interfacing with the server system 102a, all transactions of a user may be automatically submitted for review according to the method 700. In some embodiments, transactions may be transmitted to the server system by 1) the user scanning a bar code or other optical code printed on a receipt with a user device 108, 2) the user device 108 transmitting some representation of the optical code to the server system 102a and 3) the server system 102a identifying a transaction record corresponding to the transmitted representation of the optical code.

In some embodiments, the server system 102a may limit a number of receipts that may be submitted by a customer, e.g. for a specific user account. For example, N transactions may be process per week for the customer. In some embodiments, multiple limits on receipts for multiple corresponding time period may be imposed. For example, only N transactions per week or M transactions per month may be allowed by the server system 102a to be processed according to the methods described herein for purposes of determining a credit based on price differences.

The method 700 may further include identifying 704 from the received transaction record the item identifiers of items purchased as part of the transaction and the price for each item. For example, fields of the form <item identifier, price paid> may be filled with the item identifier and purchase price for some or all items listed as having been purchased in a transaction record. The item identifier may be a proprietary product identifier for a product catalog of a merchant or a universal identifier (e.g. a universal product code (UPC).

For some or all of the identified 704 items, corresponding items may be identified in third party pricing data. In particular, a lowest price for each item identifier may be identified among the third party pricing data. As noted above, pricing data may include advertised prices exclusively. Pricing data may also include the sale price for some items regardless of whether that price is advertised, e.g. an everyday, on the shelf price for an item at a third party retail outlet. Pricing data searched to identify 706 corresponding third party prices may be limited to pricing data for retail stores within a threshold proximity of the POS or retail location identified by the transaction record that is the subject of the method 700. For example, third party records may include an item identifier and a price at which that item identifier is offered for sale. A third party record for an item identifier may further include a date range in which the product was offered for sale. For example, the threshold may reference a geographical or political region (neighborhood, city, county, state, etc.) or may specify a circular area having a radius R with respect to the POS or store location indicated in the transaction record. In some embodiments, the third party retail outlets chosen for obtaining third party pricing data to compare to a transaction may be selected according to a function that takes into account a third party outlet's distance from the transaction store and the competitive environment of the transaction store. For example, retail stores may also be identified according to an algorithm that analyzes various aspects of the local market including the retail location for the transaction record. For example, in a market where there is a large concentration of stores, the radius R from which third party retail outlets may be selected for comparison may be smaller than for a rural area where stores are more distributed. Other aspects of the environment of the transaction store may also be used to identify third party outlets form which to use pricing data.

Identifying the lowest price among the third party pricing data for each item identifier of at least a portion of the item identifiers in a transaction may include determining a per-unit cost for corresponding items in the third party pricing data. For example, if a product corresponding to an item identifier is offered for sale as a buy N at price P per unit and get M free, then the price of an individual instance of that product may be prorated to be (N/(N+M))*P. This prorated price may then be used for purposes of determining whether a price is the lowest as compared to prices offered for that product by other entities and for comparison with the purchase price for the corresponding item identifier in the transaction record. In some instances, where items are sold by a unit of measure, such as weight, the cost per unit weight for an item may also be determined form the third party pricing data. For example, this approach may be applied to produce, meat, or the products sold by weight, volume, or some other unit of measurement. In some instances, products may be offered for sale at a certain price at limit of N per customer. Accordingly, where a third party promotion imposes such a limit, this limit may likewise be imposed when assigning credits. For example, where a third party price is offered only for N items and a customer buys M items, M being greater than N, the customer may be assigned a credit based on the difference between the purchase price paid for N of the M items and the third party price. For the remaining M-N items a credit may still be assigned if some other promotion or third party price is found to be lower than the purchase price paid.

The method 700 may further include, for each item identifier of some or all of the item identifiers of the transaction record determining 708 a price difference between the price paid for the item identifier and a lowest price found for the each item identifier in the third party pricing data. In particular, refund identifiers may be identified that are item identifiers of the transaction for which a lower third party was found for a corresponding product. A credit for the transaction record according to the price differences determined at step 408 may then be determined 710, e.g. the sum of the price differences between the purchase price of each of the refund identifier and the corresponding third party price. For example, a credit equal to Pₜ-P₃ may be assigned for each item identifier for which Pₜ-P₃ is a positive number, where to Pₜ is the price paid as indicated by the transaction record and P₃ is the lowest corresponding third party price identified at step 706 for the item identifier. The sum of the credits for each item identifier as determined 710 may then be assigned to the user associated with the transaction record, such as by assigning a credit equal to the sum of the credits to an account associated with a same user identifier as included in the transaction record. In some embodiment, the method 700 may include generating 712 a gift card, gift code, coupon, or some other data used to uniquely identify an account to which the credit was assigned or to represent the value of the credit. As noted above, the credit determined at 710 may instead be assigned to a roll-up account to be applied toward purchase of a wish list item as described above with respect to FIGS. 3 and 6.

In some embodiments, credits assigned according to the methods described herein may be transmitted for display in a portal with listing credits for various transactions. Upon selecting of a transaction a portal may display information about a specific transaction and the credits assigned based thereon according to the methods described herein. In some embodiments, a portal may be displayed summarizing information for a specific transaction, the portal including a map displaying the location of third party stores at which a lower price was found and for which a credit was assigned according to the methods disclosed herein.

The method 400 may further include redeeming 714 the credit. The credit may be redeemed in any manner known in the art. For example, a code may be transmitted to the user. The code may then be presented at the POS 106. The code may be input to the POS 106 that either independently validates the code or transmits it to the server system 102a. Upon determining that the code is valid, such as by receiving a response from the server system indicating that it is valid, the POS 106 may apply the corresponding credit to a transaction. The code may include text (letters, numbers, other typographic symbols), an optical code (bar code, quick response (QR) code, or the like). In some embodiments, the server system 102a may invoke mailing of a gift card to the customer or crediting of an account of the customer that has a card with a magnetic strip encoding an account identifier (e.g. debit card).

Referring to FIG. 7B, in some embodiments, a method 716 may include steps 702-710 as for the method 7A. In the method 716, a credit multiplier may be applied 718 to the credit determined at step 710, e.g. 1.5, 2, 3, or some other integer or floating point value greater than one. In some embodiments, the multiple may be less than one. The credit may then be assigned 720 to a debit card account or to a roll-up account of the user as determined by user preference (see discussion of step 308 of FIG. 3). For example, a debit card having a checking account associated therewith or used exclusively by means of a debit card. For example, an AM-EX BLUEBIRD account provided by cooperation between WAL-MART and AMERICAN EXPRESS. In some embodiments, a user may be presented a choice between 1) a gift card or code or other assignment of credit to the user and 2) assignment of a credit to a debit card after applying some multiple. If a user selection of assignment to a debit card is received, such as from a user device 108, the server system 102a may then perform the method 716 of FIG. 7B. If not, the method 700 of FIG. 7A may be performed by default.

The methods 7A and 7B may include performing fraud prevention methods, price determination methods, and other methods described in:

U.S. application Ser. No. 14/292,633 filed May 30, 2014, and entitled SYSTEMS AND METHODS FOR PRICE MATCHING AND COMPARISON;

U.S. application Ser. No. 14/292,681 filed May 30, 2014, and entitled FRAUD PREVENTION SYSTEMS AND METHODS FOR A PRICE COMPARISON SYSTEM;

U.S. application Ser. No. 14/292,629 filed May 30, 2014, and entitled RETURN PROCESSING SYSTEMS AND METHODS FOR A PRICE COMPARISON SYSTEM;

U.S. application Ser. No. 14/292,451 filed May 30, 2014, and entitled DONATION PROCESSING SYSTEMS AND METHODS FOR A PRICE COMPARISON SYSTEM; and

U.S. application Ser. No. 14/292,701 filed May 30, 2014, and entitled PRICE COMPARISON SYSTEMS AND METHODS.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method for roll-up payments comprising:
receiving, by a server system, a wish list associated with a user identifier and including one or more un-purchased item identifiers received from a user associated with the user identifier, the one or more un-purchased item identifiers each having a purchase price associated therewith, the wish list further including a wish list funding amount;
receiving, by the server system, a record of a first transaction concluded on a point of sale (POS), the record including a user identifier, one or more purchased item identifiers, and a price paid for each item identifier of the one or more purchased item identifiers;
subsequent to the first transaction, identifying, by the server system, for each item identifier of at least a portion of the one or more purchased item identifiers, a third party record, the third party record corresponding to the each item identifier and having a third party price;
subsequent to the first transaction, identifying, by the server system, one or more refund identifiers of the one or more purchased item identifiers, the third party price of the third party record corresponding to the refund identifiers being less than the price paid for the one or more refund identifiers by one or more price differences; and
calculating, by the server system, a credit amount corresponding to the one or more price differences;
increasing, by the server system, the wish list funding amount by the credit amount responsive to identifying the one or more refund identifiers;
determining whether the wish list funding amount meets the purchase price of at least one un-purchased item identifier of the one or more un-purchased item identifiers of the wish list; and
generating a notification to the user responsive to determining that the amount of the wish list funding amount meets the purchase price of the at least one un-purchased item identifier.

2. The method of claim 1, further comprising, transmitting a report to the user, the report including a price comparison between the prices paid for the one or more refund identifiers and the third party prices corresponding to the refund identifiers.

3. The method of claim 1, further comprising:
generating a purchase request for the at least one un-purchased item identifier responsive to determining that the wish list funding amount meets the purchase price of the at least one un-purchased item identifier; and
decreasing the wish list funding amount by the purchase price of the at least one un-purchased item identifier responsive to generating the purchase request.

4. The method of claim 3, wherein generating the purchase request further comprises,
in response to determining that the wish list funding amount meets the purchase price of the at least one un-purchased item identifier, transmitting a purchase confirmation request to a client device associated with the user identifier;
receiving a confirmation message from the client device; and
generating the purchase request in response to receiving the confirmation message.

5. The method of claim 1, further comprising:
receiving, by the server system, a report of a second transaction in process on one of the POS and a different POS, the record including the user identifier and a transaction price;
increasing, by the server system, the transaction price by an increment amount to obtain an incremented transaction price;
transmitting, by the server system, the incremented price to the one of the POS and the different POS;
receiving, by the server system, a record of the second transaction including a record of payment of the incremented transaction price; and
in response to receiving the record of the second transaction, increasing, by the server system, the wish list funding amount by the increment amount.

6. The method of claim 5, wherein increasing the transaction price by the increment amount to obtain the incremented transaction price further comprises:
transmitting, by the server system, a request to confirm incrementing of the transaction price to a client device associated with the user identifier;
receiving, by the server system, a confirmation message from the client device; and
in response to receiving, by the server system, the confirmation message, increasing the transaction price by the increment amount to obtain the incremented transaction price.

7. The method of claim 1, wherein the one or more un-purchased item identifiers includes a plurality of un-purchased item identifiers each having a priority associated therewith; and
wherein determine whether the wish list funding amount meets the purchase price of the at least one un-purchased item identifier comprises determining that both of (a) the at least one un-purchased item identifier has a highest priority associated therewith of the priorities associated with the plurality of un-purchased item identifiers and (b) the wish list funding amount meets the purchase price associated with the at least one un-purchased item identifier.

8. The method of claim 1, wherein the one or more un-purchased item identifiers includes a plurality of un-purchased item identifiers each having an allocation percentage associated therewith; and
wherein the wish list funding amount includes a plurality of funding amounts each corresponding to one of the un-purchased item identifiers of the plurality of un-purchased item identifiers;
wherein increasing, by the server system, the wish list funding amount by the credit amount responsive to identifying the one or more refund identifiers comprises, for each un-purchased item identifiers of the plurality of un-purchased item identifiers allocating the allocation percentage corresponding to the each un-purchased item identifier of the credit amount to the funding amount of the plurality of funding amounts corresponding to the each un-purchased item identifier.

9. The method of claim 1, further comprising:
receiving, by the server system, the one or more un-purchased item identifiers from a client device associated with the user identifier; and
in response to receiving the one or more un-purchased item identifiers from the client device associated with the user identifier, storing, by the server system, the wish list.

10. The method of claim 9, further comprising:
identifying, by the server system, a related item identifier corresponding to a product conceptually related to the one or more un-purchased item identifiers;
transmitting, by the server system, to the client device, a notification of the related item identifier;
receiving, by the server system, from the client device, an acceptance of the related item identifier;
in response to receiving the acceptance, adding, by the server system, the related item identifier to the wish list.

11. A system for roll-up payments comprising:
a server system comprising one or more processors and one or more memory devices operably coupled to the one or more processors, the one or more memory devices storing executable and operational code effective to cause the one or more processors to:
receive a wish list associated with a user identifier and including one or more un-purchased item identifiers received from a user associated with the user identifier, the one or more un-purchased item identifiers each having a purchase price associated therewith, the wish list further including a wish list funding amount;
receive a record of a first transaction concluded on a point of sale (POS), the record including a user identifier, one or more purchased item identifiers, and a price paid for each item identifier of the one or more purchased item identifiers;
subsequent to the first transaction, identify, for each item identifier of at least a portion of the one or more purchased item identifiers, a third party record, the third party record corresponding to the each item identifier and having a third party price;
subsequent to the first transaction, identify one or more refund identifiers of the one or more purchased item identifiers, the third party price of the third party record corresponding to the refund identifiers being less than the price paid for the one or more refund identifiers by one or more price differences; and
calculate a credit amount corresponding to the one or more price differences;
increase the wish list funding amount by the credit amount responsive to identifying the one or more refund identifiers;
if the wish list funding amount meets the purchase price of at least one un-purchased item identifier of the one or more un-purchased item identifiers of the wish list, generate a notification to the user.

12. The system of claim 11, wherein the executable and operational code are further effective to cause the one or more processors to transmit a report to the user, the report including a price comparison between the prices paid for the one or more refund identifiers and the third party prices corresponding to the refund identifiers.

13. The system of claim 11, wherein the executable and operational code are further effective to cause the one or more processors to:
if the wish list funding amount meets the purchase price of the at least one un-purchased item identifier
generate a purchase request for the at least one un-purchased item identifier; and
decrease the wish list funding amount by the purchase price of the at least one un-purchased item identifier.

14. The system of claim 13, wherein the executable and operational code are further effective to cause the one or more processors to generate the purchase request by:
transmitting a purchase confirmation request to a client device associated with the user identifier;
receiving a confirmation message from the client device; and
generating the purchase request in response to receiving the confirmation message.

15. The system of claim 11, wherein the executable and operational code are further effective to cause the one or more processors to:
receive a report of a second transaction in process on one of the POS and a different POS, the record including the user identifier and a transaction price;
increase the transaction price by an increment amount to obtain an incremented transaction price;
transmit the incremented price to the one of the POS and the different POS;
receiving, by the server system, a record of the second transaction including a record of payment of the incremented transaction price; and
in response to receiving the record of the second transaction, increasing, by the server system, the wish list funding amount by the increment amount.

16. The system of claim 15, wherein the executable and operational code are further effective to cause the one or more processors to increase the transaction price by the increment amount to obtain the incremented transaction price by:
transmitting a request to confirm incrementing of the transaction price to a client device associated with the user identifier;
receiving a confirmation message from the client device; and
in response to receiving the confirmation message, increasing the transaction price by the increment amount to obtain the incremented transaction price.

17. The system of claim 11, wherein the one or more un-purchased item identifiers includes a plurality of un-purchased item identifiers each having a priority associated therewith; and
wherein the executable and operational code are further effective to cause the one or more processors to generate the notification if both of (a) the at least one un-purchased item identifier has a highest priority associated therewith of the priorities associated with the plurality of un-purchased item identifiers and (b) the wish list funding amount meets the purchase price associated with the at least one un-purchased item identifier.

18. The system of claim 11, wherein the one or more un-purchased item identifiers includes a plurality of un-purchased item identifiers each having an allocation percentage associated therewith; and
wherein the wish list funding amount includes a plurality of funding amounts each corresponding to one of the un-purchased item identifiers of the plurality of un-purchased item identifiers;
wherein the executable and operational code are further effective to cause the one or more processors to increase the wish list funding amount by the credit amount responsive to identifying the one or more refund identifiers comprises, by, for each un-purchased item identifiers of the plurality of un-purchased item identifiers, allocating the allocation percentage corresponding to the each un-purchased item identifier of the credit amount to the funding amount of the plurality of funding amounts corresponding to the each un-purchased item identifier.

19. The system of claim 11, wherein the executable and operational code are further effective to cause the one or more processors to:
receive the one or more un-purchased item identifiers from a client device associated with the user identifier; and
in response to receiving the one or more un-purchased item identifiers from the client device associated with the user identifier, store the wish list.

20. The system of claim 19, wherein the executable and operational code are further effective to cause the one or more processors to:
identify a related item identifier corresponding to a product conceptually related to the one or more un-purchased item identifiers;
transmit to the client device, a notification of the related item identifier;
receive from the client device, an acceptance of the related item identifier;
in response to receiving the acceptance, add the related item identifier to the wish list.
